(19) United States
(12) Patent Application Publication
(10) Pub. No.: US 2006/0134374 A1
(43) Pub. Date: Jun. 22, 2006

(54) Vinyl polymer adhesives with post-consumer recycled glass powder filler

(75) Inventors: Michael E. Bell, Lexington, VA (US); Todd M. Shail, Roanoke, VA (US)

Correspondence Address: TROUTMAN SANDERS LLP, 600 PEACHTREE STREET , NE, ATLANTA, GA, 30308, US

(73) Assignee: Mohawk Carpet Corporation

(21) Appl. No.: 11/013,861

(22) Filed: Dec. 16, 2004

(51) Int. Cl. B32B 33/00; D05C 17/02

(52) U.S. Cl. 428/97; 428/95

(57) ABSTRACT

Vinyl polymer adhesive using glass powder as a filler. The glass powder includes the use of recycled automotive and architectural glass as a filler material for several vinyl polymer adhesives, such as hot melt adhesives, polyvinyl chloride adhesives, and vinyl acetate-ethylene (VAE) emulsion adhesives. The glass powder may have an average particle size between 100 and 400 mesh.

### TECHNICAL DESCRIPTION OF THE INVENTION

The present invention is directed to vinyl polymer adhesives and more particularly to vinyl polymer adhesives using glass powder as a filler.

### BACKGROUND

Tufted carpets are composite structures in which face yarn is tufted through a primary backing so that the base of each tuft of yarn extends through primary backing and is exposed on the bottom surface of the primary backing, forming what is known in the industry as griege goods. The griege goods are then coated with at least one adhesive backing to secure the tufted face yarn to the primary backing. The adhesive backing may also be used to bind a secondary backing to the tufted carpet.

The adhesive backings are typically manufactured from synthetic materials, such as vinyl polymers, hot melt adhesives, polyolefins, polyamides, and the like. Unfortunately, these materials tend to be expensive, which may increase the manufacturing costs. To reduce the manufacturing costs, most manufactures may add filler to the adhesive backings. Typically, conventional fillers may include carbonates, sulfates, oxides, silicates, such as clay; metal salts, and the like. Because conventional fillers tend to be minerals they have to be mined, and therefore have the problems of mining associated with them.

Recently, however, carpet manufacturers started to incorporate post consumer waste products into the adhesive backing compound. One method of incorporating post consumer waste products into carpet used recycled carpet as filler for vinyl polymer adhesives. Another method used recycled glass cullet as filler in polyurethane compositions. Although both methods have proven effective as filler for adhesives, the use of recycled glass as filler has emerged as an attractive filler due to the large supply of post consumer glass products and its relatively low cost. However, efforts to incorporate recycled glass into vinyl polymer adhesives have been unsatisfactory.

Therefore, there is a need for a filler material made from recycled post consumer products for vinyl polymer adhesives, and more particularly, there is a need for a filler material that is made from recycled post consumer glass for use with vinyl polymer adhesives.

### SUMMARY OF THE INVENTION

The present invention meets the needs described above in an adhesive for carpet using recycled post consumer waste products. Generally described, the invention includes a vinyl polymer adhesive using glass powder manufactured from recycled post-consumer glass to reduce the manufacturing costs associated with the production of carpet and carpet tiles. More particularly described, the invention includes the use of recycled automotive and architectural glass for a filler material for several vinyl polymer adhesives. The recycled glass powder may be suitable as a filler for vinyl polymer adhesives, such as hot melt adhesives, polyvinyl chloride (PVC) adhesives, and vinyl acetate-ethylene (VAE) emulsion adhesives. The various aspects of the present invention may be more clearly understood and appreciated from a review of the following detailed description of the disclosed embodiments and by reference to the appended drawings and claims.

### BRIEF DESCRIPTION OF THE FIGURES

FIG. 1 is an illustration of a cross-section of a carpet.

### DETAILED DESCRIPTION OF THE EMBODIMENTS

The present invention is typically embodied in a vinyl polymer adhesive for carpets using glass powder manufactured from recycled post-consumer glass. The glass powder may be used with latex adhesives, hot melt adhesives, vinyl polymer adhesives, polyolefin adhesives, and water-based VAE emulsion adhesives. The glass powder may be made from any type of recycled glass products, such as automotive glass, architectural glass, flint glass, E glass, borosilicate glass, brown glass (bottle glass), and green glass (bottle glass), and the like. Preferably, the glass powder has an average particle size between 100 mesh and 400 mesh. Although the present invention describes using glass powder as filler for carpet adhesive, those skilled in the art will appreciate that glass powder may be used as filler for other polymer products such as extruded thermoplastics and thermoset materials that typically use calcium carbonate or other fillers without departing from the scope of the invention. Such thermoplastics and thermoset materials may include, but not limited to roofing materials, awning materials, road surfacing materials, tarps, building materials, such as planks and sheeting, and the like.

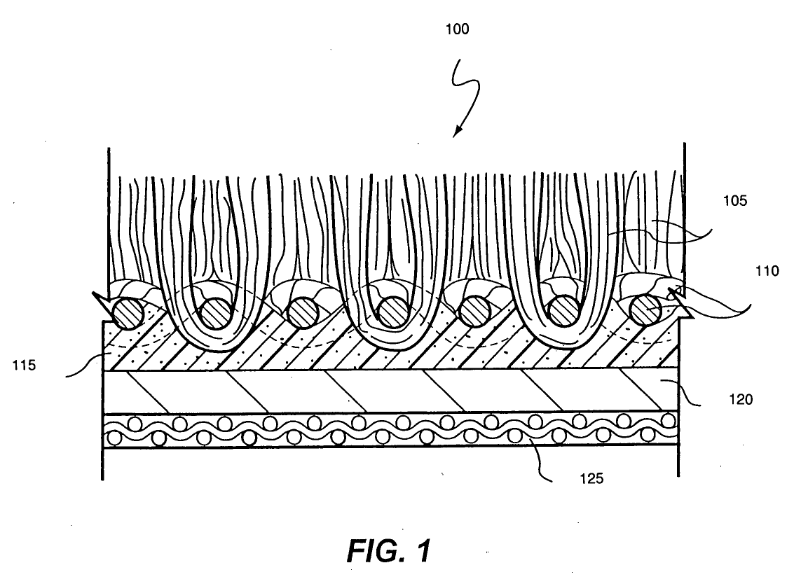

Turning now to the figures, in which like numerals refer to like elements through the several figures, FIG. 1 is a cross-sectional view of a carpet 100. The carpet 100 includes tufts of face yarn 105, which may be either tufted or woven into a primary backing 110 to form griege goods. The tufted face yarn 105 may be made from various materials, both natural and synthetic, including but not limited to cotton, wool, nylon, acrylic, polyester, polyamides, polypropylene, and other polyolefins. The primary backing 110 may be formed using any conventional natural or synthetic woven material, such as cotton, jute, rayon, paper, nylon, polypropylene and other polyolefins, polyamides, polyesters, and the like. Alternatively, other types of materials, such as non-woven webs may be used for the primary backing 115. The face yarn 105 may be tufted through the primary backing 110 so that the ends of the face yarn 105 extend in an outwardly direction from the topside of the primary backing 110. The tufting may be performed using conventional techniques that are well known in the art. Furthermore, the tufted face yarn 105 loops may be left as uncut to form an uncut pile carpet, cut to form a cut pile carpet, or partially cut to form a tip sheared carpet, as is well known in the art.

The carpet 100 also includes a primary adhesive layer 115, also known as a pre-coat, which may be applied to the underside of the primary backing 110. The main purpose of the primary adhesive layer 115 may be to penetrate the tufted face yarn 105, encapsulate the individual fibers, and bind the tufted face yarn 105 to the primary backing 110 for further manufacturing. The primary adhesive layer 115 typically has a weight in the range of approximately 2 to 50 ounces per square yard.

A secondary adhesive layer 120 may then be applied over the primary adhesive layer 115 to permanently bond the tufted face yarn 105 to the primary backing 110. The secondary adhesive layer 120 typically has a weight in the range of approximately 2 to 110 ounces per square yard and may be applied in a single step as a single layer or it may be applied in several steps in several thin layers. Both the adhesive for the primary adhesive layer 115 and the secondary layer 120 may be made from a vinyl polymer adhesive, such as a hot melt adhesive, polyvinyl chloride (PVC) adhesive, or a vinyl acetate-ethylene (VAE) emulsion adhesive.

The primary adhesive layer 115 and the second adhesive layer 120 may be applied to the griege goods using standard application techniques. For example, the primary adhesive layer 115 and the second adhesive layer 120 may be applied by puddle coating, in which a puddle of the adhesive is formed on the griege goods in front of a roller. As the griege goods are pulled through the puddle of the adhesive, the roller acts to scrape off any excess material and gauge on the correct amount of adhesive. Alternatively, the first adhesive layer 115 and the second adhesive layer 120 may be applied by passing the bottom of the griege goods over an applicator, such as a roller, which is positioned within a reservoir containing the adhesive compound in a molten state. The molten adhesive is then applied to the back of the griege goods as it comes in contact with the roller. The griege goods may then be passed under a scraper or doctor blade to set the thickness of the molten adhesive applied to the carpet backing. Furthermore, the primary adhesive layer 115 and the second adhesive layer 120 may be extruded onto the carpet backing 110. Additionally, a scrim (not shown) may be applied to the carpet 100 between the primary adhesive layer 115 and the secondary adhesive layer 120 to provide additional strength and rigidity to the carpet 100. The scrim may be a woven or non-woven material. Additionally, the carpet 100 may include a secondary backing 125 using any conventional natural or synthetic woven material, such as cotton, jute, rayon, paper, nylon, polypropylene and other polyolefins, polyamides, polyesters, and the like

The vinyl polymer adhesive compound used for the primary adhesive layer 115 and/or the secondary adhesive layer 120 may include glass powder as a filler. Glass powder is typically produced by recycling post consumer glass products, in particular automotive and architectural glass, also known as plate glass. However, other types of glass, such as flint glass, E glass, borosilicate glass, brown glass (bottle glass), and green glass (bottle glass) and combinations thereof may also be used to form the glass powder. The post consumer glass is ground into powder using techniques that are well known in the art. Typically, the glass powder filler may be added to the vinyl polymer adhesive in amounts up to 75 percent of the total weight (wt. %) of the vinyl polymer adhesive.

In some embodiments, the glass powder may be used to completely replace conventional fillers. That is, the glass powder may make up 100% of the filler. Additionally, the glass powder may be used in conjunction with conventional fillers to form a composite filler. For example, in some embodiments the glass powder may be mixed with carbonates such as calcium carbonate (CaO₃), cesium carbonate (CsCO₃), strontium carbonate (StCO₃), and magnesium carbonate (MgCO₃); sulfates such as barium sulfate (BaSO₃); oxides such as fly ash, iron oxide (Fe₂O₃), alumina oxide (Al₂O₃), tungsten oxide (Tg₂O₃), titanium oxide (Ti₂O₃), and silicon oxide (Si₂O₃); silicates, such as clay; metal salts; fly ash; and the like. When a composite filler is used, the glass powder may be added in amounts between approximately 5.0 and approximately 95.0 wt. % of the total weight of the composite filler, and more preferably between approximately 75.0 and approximately 95.0 wt. % of the total weight of the composite filler. The composite filler may be added in amounts up to 75 percent of the total weight of the vinyl polymer adhesive, and preferably between approximately 40 and 60 wt. % of the total weight of the vinyl polymer adhesive.

The average particle size of the glass powder may be important for the present invention. It may be desirable to have the average particle size of the glass powder as large as possible to match a desired viscosity of the vinyl polymer adhesive in the molten state. However, the size of the particles should not be so large as to cause the glass powder to precipitate out of the vinyl polymer. Therefore, to insure adequate dispersion of the glass powder in the filler, while maintaining adequate viscosities, the average size of the glass powder may range from approximately 100 mesh to 400 mesh. More particularly, in some embodiments, the average size of the glass powder may be approximately 200 mesh.

The adhesive compound used for the primary adhesive layer 115 and secondary adhesive layer 120 may also include additional additives. For example, these additives may include a surfactant to help keep the glass powder uniformly dispersed in the adhesive. Surfactants that may be suitable for use with glass powder may include nonionic, anionic, and flurosurfactants. In addition to uniformly dispersing the glass powder throughout the adhesive compound, the surfactants may also be used as a froth aid to increase the emulsification of adhesives, such as VAE emulsions. Typically, the surfactant may be present in an amount between, 0.005 and 1.0 wt. % of the total weight of the adhesive.

The adhesive compound may also contain a plasticizer to decrease the viscosity of the adhesive and also reduce the surface tension of the adhesive. Additionally, the degree of crystallinity and the congealing point of the plasticizer in the adhesive formulation control the open and set time of the adhesive, as well as the flexibility and elongation properties. Plasticizers may also play a major role in increasing the blocking point of the final adhesive, preventing the adhesive, in pellet or chip form, from sticking together during transport and storage. Suitable plasticizers may include synthetic plasticizers, such as diisononyl phthalate (DINP), phthalates, benzoates, citrates, timellitates, and other esters, tricresyl phosphate, polybutene, and organic plasticizers, such as coconut oil, waxes including waxes manufactured from crude oil refining, such paraffin wax, microcrystalline wax, and synthetic waxes, such as Fischer-Tropsch waxes. Plasticizers may be present in the adhesives in an amount between 0.0 and 50.0 percent of the total weight of the adhesive.

When polymer adhesives, especially hot melt adhesives, are heated, they may become susceptible to thermo-oxidation degradation. Therefore, to reduce the possibility of thermo-oxidation degradation, the adhesive composition of the present invention may also contain an antioxidant. Some suitable antioxidants include, but are not limited to 2,2′-methylene bis (-4-methyl-6-tert-butylphenol), 2,4,6-tri-tert-butylphenol, 2,6-di-tert-butyl-4-methylphenol, 4,4′-thio-bis (-6-tert-butyl-m-cresol), butylated hydroxy anisole, and butylated hydroxy toluene. Typically, the antioxidant may be present in the vinyl polymer adhesive in an amount up to about 2.0 percent of the total weight of the adhesive and preferably from about 0.01 to 1.0 percent of the vinyl polymer adhesive compound.

The adhesive compound may also contain a foaming agent. Any conventional foaming agent, such as but not limited to, azodicarbonamide, toluene sulfonyl seimcarbazide, and oxy bis(benzene sulfonyl) hydrazide may be used. Normally, the amount of foaming agent depends upon the amount of foaming desired in the adhesive compound. Typically, the foaming agent may be present in the adhesive in an amount between 0.1 and 2.0 wt. % of the vinyl polymer adhesive compound, and preferably in an amount of approximately 0.75 wt. % of the vinyl polymer adhesive compound.

The vinyl polymer adhesive compound may also contain a drying agent, such as oxides, and more particularly calcium oxide (CaO) to remove moisture from the vinyl polymer adhesive and decrease the set-up time. Typically, the drying agent pigment may be present in an amount equal to less than one percent of the total weight of the vinyl polymer adhesive.

The vinyl polymer adhesive may also contain a pigment, such as carbon black to provide color and increase the opaqueness of the vinyl polymer adhesive. Typically, the pigment may be present in an amount equal to less than one percent of the total weight of the vinyl polymer adhesive.

Examples of hot melt adhesive compounds, PVC adhesive compounds, and VAE emulsion adhesive compounds using glass powder as a filler in accordance with some embodiments of the present invention are discussed below in detail. Although the present invention describes using glass powder made from recycled glass as filler, those skilled in the art will appreciate that the glass powder may be used as filler for other polymer adhesives, such as polyolefins, polyamides, and the like without departing from the scope of the invention.

Hot Melt Adhesive

One embodiment of the invention uses hot melt adhesives with glass powder as a filler. A variety of filled hot melt adhesive formulations may be employed as the primary adhesive layer 115 and the secondary adhesive layer 120. The specific formulation for the hot melt adhesive, as well as the viscosity, may depend upon the type of carpet style and the materials used in constructing a particular carpet. Although the hot melt adhesive typically contains a single vinyl polymer as the base polymer, the hot melt adhesives may combine several different vinyl polymers as the base polymer to control the basic properties.

One embodiment of a filled hot melt may comprise between approximately 12.0 to 20.0 wt. % of an ethylene vinyl acetate (EVA) polymer, and more preferably between 15 and 18 wt. %, as the base polymer; between approximately 0.0 to 55.0 wt. % of the glass filler, and more preferably between 47.0 to 50.0 wt. % of the glass filler and have a viscosity of less than 20,000 cps.

The hot melt adhesive may also contain up to about 40 wt. % of a tackifying agent. The hot melt adhesive preferably contains between approximately 20-40 wt. % of the tackifying agent. The tackifying agent may be any suitable tackifying agent known generally in the art, such as natural and synthetic resins and rosin materials. Classes of tackifying resins that may be used include but are not limited to, coumarone-indene resins, terpene resins, including also styrenated terpenes, the butadiene-styrene resins, the polybutadiene resins, and the hydrocarbon resins. The tackifying agent may also include rosin materials, low molecular weight styrene hard resins, disproportionated pentaerythritol esters, and copolymers of aromatic and aliphatic monomer systems. The rosin material may be gum, wood or tall oil rosin but preferably is tall oil rosin. Also the rosin material may be a modified rosin such as dimerized rosin, hydrogenated rosin, disproportionated rosin, or esters of rosin.

One embodiment of a hot melt an adhesive using glass powder as a filler may contain about 12-20 wt. % of an ethylene vinyl acetate (EVA) polymer, and more preferably between 15.0 and 18.0 wt. %, of an ethylene vinyl acetate (EVA) polymer; about 20.0 to 60.0 wt. % of the glass filler, and more preferably between 40.0 to 50.0 wt. % of the glass filler; between 20.0 to 40.0 wt. % t of a tackifying resin; and have a viscosity of less than 20,000 cps. A standard hot melt adhesive that may be used with glass powder as the filler may be the Lees UNIBOND™, manufactured by Mohawk Carpets, Dalton, Ga. An example of a hot melt adhesive in accordance with some embodiments of the present invention may contain the following materials summarized in Table 1.

TABLE 1
Summary of Composition for Hot Melt Adhesive.

| | Formula | Formula | Formula | Formula | Formula |
|---|---|---|---|---|---|
| | 1 | 2 | 3 | 4 | 5 |
| Ingredient | Wt. % | Wt. % | Wt. % | Wt. % | Wt. % |
| Base Polymer | | | | | |
| EVA 1 | 15-18 | 0 | 0 | 0 | 0 |
| EVA 2 | 0 | 15-18 | 0 | 0 | 0 |
| EVA 3 | 0 | 0 | 15-18 | 0 | 0 |
| EVA1 + EVA2 | | | | 15-18 | 15-18 |
| Filler | | | | | |
| Glass Powder | 40-50 | 40-50 | 40-50 | 40-50 | 40-50 |
| CaCO3 | <10 | <10 | <10 | <10 | <10 |
| Tackifying Resin | 20-40 | 20-40 | 20-40 | 20-40 | 20-40 |
| Total | 100 | 100 | 100 | 100 | 100 |
| Viscosity at | 19,400 | 6,000 | 13,500 | 13,500 | 12,500 |
| 335° F. (cps) | | | | | |

The five separate formulas of the hot melt adhesive were prepared with approximately 48 wt. % glass powder filler made from ground automotive glass with an average particle size of approximately 200 mesh. The five different formulas of hot melt adhesive were prepared using three different EVA polymers, both individually and combinations thereof as the base polymer. As seen from Table 1, Formula 1, which used EVA 1 as the base polymer produced a hot melt adhesive with a viscosity of approximately 19,400 cps at 335° F. Formula 2, which used EVA 2 as the base polymer produced a hot melt with a viscosity of 6,000 cps at 335° F. and Formula 3, which used EVA 3 as the base polymer produced a viscosity of approximately 13,500 cps at 335° F.

Formulas 4 and 5 used a combination of EVA 1 and EVA 2 polymers as the base polymer for the hot melt adhesive with different ratios of EVA 1 to EVA 2. In particular, Formula 4 used a combination, which had a higher ratio of the EVA 1 polymer to EVA 2 polymer than did Formula 5. Formula 4 produce a hot melt adhesive with a viscosity of approximately 13,500 cps at 335° F. Formula 5, which used a lower percentage of the EVA 2 polymer, produced a hot melt adhesive with a viscosity of approximately 12,500 cps at 335° F.

PVC Adhesives

In another embodiment of the present invention, the vinyl polymer adhesive is a polyvinyl chloride (PVC). The PVC adhesives generally may contain a single PVC resin. However, the PVC adhesives may also be a PVC plastisol that may contain several different PVC resins to provide desired properties, such as the strength, the toughness, and the viscosity of the vinyl polymer adhesive.

An example of a PVC adhesive composition utilizing glass powder as filler may contain approximately less than 25 wt. % of a single PVC resin, or a combination of two or more PVC resins, and more preferably between approximately 15 and 25 wt. % of a combination of two or more PVC resins as the base resin; and between 30-60 wt. % of the glass powder filler, and more particularly between 25-35 wt. % of the glass powder filler. The filler may also contain between approximately 25-35 wt. % of a traditional filler, such as CaCO₃, and more particularly between 15-25 wt. % of the traditional filler. Additionally, the PVC adhesive may also contain approximately 10 to 25 wt. % of a plasticizer; and about less than one (1) percent by weight of additional additives, such as a surfactant, a drying agent, and a pigment. The example PVC adhesive had a viscosity of approximately 14,000 cps at 25° C. A summary of the composition of a PVC adhesive in accordance with some embodiments of the present invention is summarized in Table 2.

TABLE 2
Summary Composition for PVC Adhesive.

| Ingredients | Wt. % (Approximate) |
|---|---|
| PVC Resin | 15-25 |
| Plasticizer | 10-25 |
| Filler | |
| Glass | 25-35 |
| CaC03 | 15-25 |
| Additives | <1 |
| Total | 100 |
| Viscosity (cps @ 25° C.) | 14,000 |

VAE Emulsion

A suitable VAE emulsion adhesive using powder glass as a filler may be one that contains approximately less than 50 wt. % of a VAE compound, and more preferably between 35-40 wt. % of the VAE compound; and between about 40 and 80 wt. % of a glass powder filler, and more preferably between about 50 and 70 wt. % of the glass powder filler. Additionally, the VAE emulsion adhesive may also contain about less than 1 wt. % of a compatibilizer; about less than 1 wt. % of a pigment, such as carbon black; about less than 1 wt. % of a foaming agent; and about less than 1 wt. % of a stabilizer. The resulting VAE emulsion produced a viscosity of approximately 4,000 cps at 25° C. The example VAE emulsion adhesive using glass powder as the filler is summarized in Table 3.

TABLE 3
Summary of VAE Emulsion Composition.

| Ingredient | Wt. % (Approximate) |
|---|---|
| Water | 5-10 |
| VAE compound | 35-40 |
| Compatibilizer | 0.25-0.50 |
| Carbon Black | 0.12 |
| Foaming Agent | <1 |
| Stabilizer | <1 |
| CaCO₃ Filler | 0.0 |
| Glass Powder Filler | 50-70 |
| Total | 100 |
| Viscosity (cps @ 25° C.) | 4,000 |

Other alternative embodiments will become apparent to those skilled in the art to which an exemplary embodiment pertains without departing from its spirit and scope. Accordingly, the scope of the present invention is defined by the appended claims rather than the foregoing description.

We claim:

1. A vinyl polymer adhesive, comprising:
a vinyl polymer; and
a filler comprising glass powder.

2. The vinyl polymer adhesive of claim 1, wherein the glass powder has an average particle size in the range of approximately 100 mesh to 400 mesh.

3. The vinyl polymer adhesive of claim 1, wherein the glass powder has a particle size of approximately 200 mesh.

4. The vinyl polymer adhesive of claim 1, wherein the filler comprises up to approximately 75 percent by weight of the vinyl polymer adhesive.

5. The vinyl polymer adhesive of claim 1, wherein the glass powder comprises plate glass.

6. The vinyl polymer adhesive of claim 1, wherein the glass powder comprises glass selected from the list consisting essentially of amber glass, green glass, flint glass, borosilicate glass, E glass, plate glass, and combinations thereof.

7. A vinyl polymer adhesive, comprising:
at least one ethylene vinyl acetate (EVA) copolymer;
a resin; and
a filler comprising glass powder.

8. The vinyl polymer adhesive of claim 7, wherein the filler comprises between approximately 40 to 50 percent by weight of the adhesive.

9. The vinyl polymer adhesive of claim 7, wherein the resin is a tackifying resin.

10. The vinyl polymer adhesive of claim 7, wherein the glass powder has an average particle size in the range of approximately 100 mesh to 400 mesh.

11. The vinyl polymer adhesive of claim 7, wherein the glass powder has a particle size of approximately 200 mesh.

12. The vinyl polymer adhesive of claim 8, wherein the filler further comprises calcium carbonate.

13. The vinyl polymer adhesive of claim 12, wherein the calcium carbonate comprises approximately less than 10 percent by weight of the vinyl polymer adhesive.

14. The vinyl polymer adhesive of claim 7, wherein the vinyl polymer adhesive has a viscosity of less than 20,000 cps at 335 degrees Fahrenheit.

15. The vinyl polymer adhesive of claim 7, wherein the glass powder comprises plate glass.

16. The vinyl polymer adhesive of claim 7, wherein the glass powder comprises glass selected from the list consisting essentially of amber glass, green glass, flint glass, borosilicate glass, E glass, plate glass, and combinations thereof.

17. A carpet containing at least in part a recycled product, the carpet comprising:
a tufted face;
a primary backing;
a primary backing adhesive; and
a secondary backing adhesive,
wherein at least one of the backings comprises a vinyl polymer adhesive comprising:
at least one ethylene vinyl acetate (EVA) copolymer;
a resin; and
a filler comprising glass powder derived from recycled glass.

18. The carpet of claim 17, wherein the filler comprises between approximately 40 to 50 percent by weight of the adhesive.

19. The carpet of claim 17, wherein the resin is a tackifying resin.

20. The carpet of claim 17, wherein the glass powder has a particle size in the range of approximately 100 mesh to 400 mesh.

21. The carpet of claim 17, wherein the glass powder has a particle size of approximately 200 mesh.

22. The carpet of claim 18, wherein the filler further comprises calcium carbonate

23. The carpet of claim 22, wherein the calcium carbonate comprises approximately between 5-25 percent by weight of the filler.

24. The carpet of claim 17, wherein the vinyl polymer adhesive has a viscosity of less than 19,000 cps at 335 degrees Fahrenheit.

25. The carpet of claim 17, wherein the glass powder comprises plate glass.

26. The carpet of claim 17, wherein the glass powder comprises glass selected from the list consisting essentially of amber glass, green glass, flint glass, borosilicate glass, E glass, plate glass, and combinations thereof.

27. A vinyl polymer adhesive composition, comprising:
at least one poly vinyl chloride (PVC) resin;
a filler comprising glass powder; and
a plasticizer.

28. The vinyl polymer adhesive composition of claim 27, further comprising at least one additive selected from the group consisting essentially of a surfactant, a drying agent, and a pigment.

29. The vinyl adhesive composition of claim 27, wherein the glass powder comprises between approximately 25 to 35 percent by weight of the adhesive.

30. The vinyl polymer adhesive composition of claim 27, wherein the glass powder has a particle size in the range of approximately 100 mesh to 400 mesh.

31. The vinyl polymer adhesive composition of claim 27, wherein the glass powder has a particle size of approximately 325 mesh.

32. The vinyl polymer adhesive composition of claim 28, wherein the filler further comprises calcium carbonate.

33. The vinyl adhesive composition of claim 32, wherein the calcium carbonate comprises between approximately 5 to 25 percent by weight of the vinyl polymer adhesive.

34. The vinyl adhesive composition of claim 27, wherein the at least one poly vinyl chloride (PVC) resin comprises a plastisol.

35. The vinyl adhesive composition of claim 27 wherein the glass powder comprises plate glass.

36. The vinyl adhesive composition of claim 27, wherein the glass powder comprises glass selected from the list consisting essentially of amber glass, green glass, flint glass, borosilicate glass, E glass, plate glass, and combinations thereof.

37. A carpet containing at least in part a recycled product, the carpet comprising:
a tufted face;
a primary backing;
a primary backing adhesive; and
a secondary backing adhesive,
wherein at least one of the adhesives comprises:
at least one poly vinyl chloride (PVC) resin;
a filler comprising glass powder; and
a plasticizer.

38. The carpet of claim 37, further comprising at least one additive selected from the group consisting essentially of a surfactant, a drying agent, and a pigment.

39. The carpet of claim 37, wherein the glass powder comprises between approximately 25 to 35 percent by weight of the adhesive.

40. The carpet composition of claim 37, wherein the glass powder has a particle size in the range of approximately 100 mesh to 400 mesh.

41. The carpet composition of claim 37, wherein the glass powder has a particle size of approximately 325 mesh.

42. The carpet composition of claim 39, wherein the filler further comprises calcium carbonate.

43. The carpet of claim 42, wherein the calcium carbonate comprises between approximately 15 to 25 percent by weight of the vinyl polymer adhesive.

44. The carpet of claim 37, wherein the at least one poly vinyl chloride (PVC) resin comprises a plastisol.

45. The carpet of claim 37 wherein the glass powder comprises plate glass.

46. The carpet of claim 37, wherein the glass powder comprises glass selected from the list consisting essentially of amber glass, green glass, flint glass, borosilicate glass, E glass, plate glass, and combinations thereof.

47. A vinyl polymer adhesive composition, comprising:
a vinyl acetate-ethylene (VAE) copolymer;
water;
a foaming agent; and
a filler comprising glass powder.

48. The vinyl polymer adhesive composition of claim 47, further comprising at least one additive selected from the group consisting essentially of a compatibilizer, a stabilizer, and a pigment.

49. The vinyl polymer adhesive composition of claim 47, wherein the glass powder has a particle size in the range of approximately 100 mesh to 400 mesh.

50. The vinyl polymer adhesive composition of claim 47, wherein the glass powder has a particle size of approximately 200 mesh.

51. The vinyl polymer adhesive composition of claim 47, wherein the filler comprises between approximately 50 to 70 percent by weight of the adhesive.

52. The vinyl polymer adhesive composition of claim 47, wherein the filled vinyl polymer adhesive has a viscosity in the range of approximately 4,000 cps at 25 degrees Celsius.

53. The vinyl polymer adhesive composition of claim 47 wherein the glass powder comprises plate glass.

54. The adhesive composition of claim 47, wherein the glass powder comprises glass selected from the list consisting essentially of amber glass, green glass, flint glass, borosilicate glass, E glass, plate glass, and combinations thereof.

55. A carpet containing at least in part a recycled product, the carpet comprising:
a tufted face;
a primary backing;
a primary backing emulsion adhesive; and
a secondary backing emulsion adhesive, wherein at least one of the adhesives comprises:
a vinyl acetate-ethylene (VAE) copolymer;
water;
a foaming agent and
a filler comprising glass powder.

56. The carpet of claim 55, further comprising at least one additive selected from the group consisting essentially of a compatibilizer, a stabilizer, and a pigment.

57. The carpet of claim 55, wherein the glass powder has a particle size in the range of approximately 100 mesh to 400 mesh.

58. The carpet of claim 55, wherein the glass powder has a particle size of approximately 200 mesh.

59. The carpet of claim 58, wherein the filler comprises between approximately 50 to 70 percent by weight of the adhesive.

60. The carpet of claim 55, wherein the filled vinyl polymer adhesive has a viscosity in the range of approximately 4,000 cps at 25 degrees Celsius.

61. The carpet of claim 55 wherein the glass powder comprises plate glass.

62. The carpet of claim 55, wherein the glass powder comprises glass selected from the list consisting essentially of amber glass, green glass, flint glass, borosilicate glass, E glass, plate glass, and combinations thereof.
